(19) United States
(12) Patent Application Publication
(10) Pub. No.: US 2013/0139318 A1
(43) Pub. Date: Jun. 6, 2013

(54) BED WITH WEIGHT BEARING CONTROL SYSTEM

(71) Applicant: Ohad Paz, Tel Aviv (IL)

(72) Inventor: Ohad Paz, Tel Aviv (IL)

(21) Appl. No.: 13/814,507

(22) PCT Filed: Aug. 3, 2011
(86) PCT No.: PCT/IL11/00627

§ 371 Date: Feb. 6, 2013

Related U.S. Application Data
(60) Provisional application No. 61/344,497, filed on Aug. 6, 2010.
(60) Provisional application No. 61/457,777, filed on Jun. 1, 2011.

(51) Int. Cl. A61G 7/002

(52) U.S. Cl. CPC A61G 7/002
USPC 5/624

(57) ABSTRACT

Supporting apparatus for supporting a user in one of a plurality of positions and for moving the user from one position to another, comprises a base; a body support carried by the base for supporting the user in a horizontal position; a feet support engageable with the under surface of the user's feet; a tilting mechanism coupled to and between the base and the body support to enable tilting the body support to a horizontal, inclined, or vertical position with respect to the base; a pressure-sensor carried by the feet-support which senses the pressure applied by the user to the feet-support and produces an output corresponding thereto; a weight sensor which senses the weight of the user on the body support and produces an output corresponding thereto; and a processor which processes the outputs of the pressure-sensor and the weight-sensor, producing an output corresponding thereto.

### RELATED APPLICATIONS

The present application claims the priority dates of U.S. Provisional Applications 61/344,497 filed Aug. 6, 2010, and 61/457,777 filed Jun. 1, 2011, and incorporates herein by reference the disclosures in those applications.

### FIELD AND BACKGROUND OF THE INVENTION

The present invention relates to multi-position supporting apparatus, and particularly to hospital beds constructed to support the users in many different positions, including a horizontal position, a vertical position, and a reclining position. Such hospital beds are provided to facilitate patients or other users entering the bed or exiting from the bed, and also to facilitate treatment of the user while occupying the bed. Examples of multi-position supporting apparatus with respect to which the invention is particularly useful are described in our prior patent applications Ser. No. 11/715,410 filed Mar. 8, 2007 and Ser. No. 12/542,913 filed Aug. 18, 2009, the contents of which applications are also incorporated herein by reference.

Such supporting apparatus generally includes a base for supporting the apparatus on a horizontal surface; a body support carried by the base for supporting the user in a horizontal position and having a feet-support at one end engageable with the under surface of the user's feet; and a tilting mechanism coupled to and between the base and the body support to enable tilting the body support to a horizontal position, an inclined position, or a vertical position with respect to the base. Thus, the body support, and the user supported thereon, can be moved to a horizontal position or to a desired reclining position for normal rest or for a particular treatment, and to a vertical position for exiting from the apparatus.

The two above-cited pending patent applications also include a pressure sensor carried by the feet support for sensing the pressure applied by the user to the feet support upon relative movement between it and the body support longitudinally of the bed support. The latter sensor is used for controlling a motor drive for the tilting mechanism in response to the pressure applied by the user's feet against the pressure, to prevent shifting in position of the user's body when the body support moves from the horizontal position to a reclined position or to the vertical position.

### OBJECTS AND BRIEF SUMMARY OF THE INVENTION

An object of the present invention is to provide supporting apparatus of the foregoing type with further features useful for better controlling the position of the bed in accordance with a particular treatment that may be required, or for providing information concerning the pressure/weight the user is putting on the feet support The invention gives the ability for measuring and controlling weight bearing control of the user in respect to the pressure applied on the feet support, with possibility of knowing the ratio between the patient's body weight, the pressure applied on the feet support and the ratio between the two. Such invention is important for many medical applications, for fall prevention and for physical therapy treatment.

According to a broad aspect of the present invention, there is provided supporting apparatus for supporting a user in one of a plurality of positions and for moving the user from one position to another, comprising: a base for supporting the apparatus on a horizontal surface; a body support carried by the base for supporting the user in a horizontal position; a tilting mechanism coupled to and between the base and the body support to enable tilting the body support to a horizontal position, inclined position, or vertical position with respect to the base; a feet-support engageable with the under surface of the user's feet upon relative movement between it and the body support longitudinally of the body support; a pressure-sensor carried by the feet-support for sensing the pressure applied by the user to the feet-support and for producing an output corresponding thereto; a weight sensor for sensing the weight of the user on the body support and for producing an output corresponding thereto; and a processor for processing the outputs of the pressure-sensor and the weight-sensor for producing an output corresponding thereto.

The output of the weight sensor will be the same for all positions of the supporting apparatus. The output of the pressure-sensor carried by the feet-support, however, will depend on the pressure applied by the user's feet against the feet support due to gravity, and will therefore vary in accordance with the angular position of the body support with respect to the base.

In the described preferred embodiments, the base is of rectangular configuration, and the weight sensor comprises a pressure sensor at each of its four corners. In addition, the apparatus further comprises a display for displaying an output of the processor. Preferably, the display is carried by a separate unit attached to the bed, but could also be incorporated in the bed, e.g. the headboard or footboard of the bed.

According to further features in the described preferred embodiments, the supporting apparatus further comprises a motor drive for driving the tilting mechanism. The motor drive is controlled by an output of a processor which can be started or stopped a tilting operation according to a predetermined pressure applied to the feet support pressure sensor. The supporting apparatus may further include an alarm (audio and/or visual) which is actuated when the pressure sensor on the feet support senses an excessive pressure or a predefined pressure.

In the described preferred embodiments, the processor produces a first output corresponding to the weight of the user; a second output corresponding to the pressure applied by the user's feet on the feet-support, and a third output corresponding to the ratio of the first and second outputs. The processor may also produce a fourth output corresponding to the angle of tilt of the body support with respect to the base. All the foregoing outputs are preferably displayed selectively in one display unit, or separately in a plurality of display units. One or more of such outputs may also be used for controlling any of the drives of the supporting apparatus.

Further features and advantages of the invention will be apparent from the description below.

### BRIEF DESCRIPTION OF THE DRAWINGS

The invention is herein described, by way of example only, with reference to the accompanying drawings, wherein:

FIG. 1 illustrates one form of known supporting apparatus with respect to which the invention is particularly useful;

FIG. 2 illustrates one embodiment of the invention of the present application incorporated in the supporting apparatus of FIG. 1;

FIGS. 3-5 illustrate the supporting apparatus of FIG. 2 in a horizontal position, a reclining position, and a substantially vertical position, respectively;

FIG. 6 is a block diagram schematically illustrating the main components in the embodiment of the invention illustrated in FIGS. 2-5;

FIG. 7 is a view similar to that of FIG. 5 but illustrating a second embodiment of the invention; and

FIG. 8 is a block diagram schematically illustrating the main components in the embodiment of the invention illustrated in FIG. 7.

It is to be understood that the foregoing drawings, and the description below, are provided primarily for purposes of facilitating understanding the conceptual aspects of the invention and possible embodiments thereof, including what is presently considered to be a preferred embodiment. In the interest of clarity and brevity, no attempt is made to provide more details than necessary to enable one skilled in the art, using routine skill and design, to understand and practice the described invention. It is to be further understood that the embodiments described are for purposes of example only, and that the invention is capable of being embodied in other forms and applications than described herein.

### DESCRIPTION OF PREFERRED EMBODIMENTS

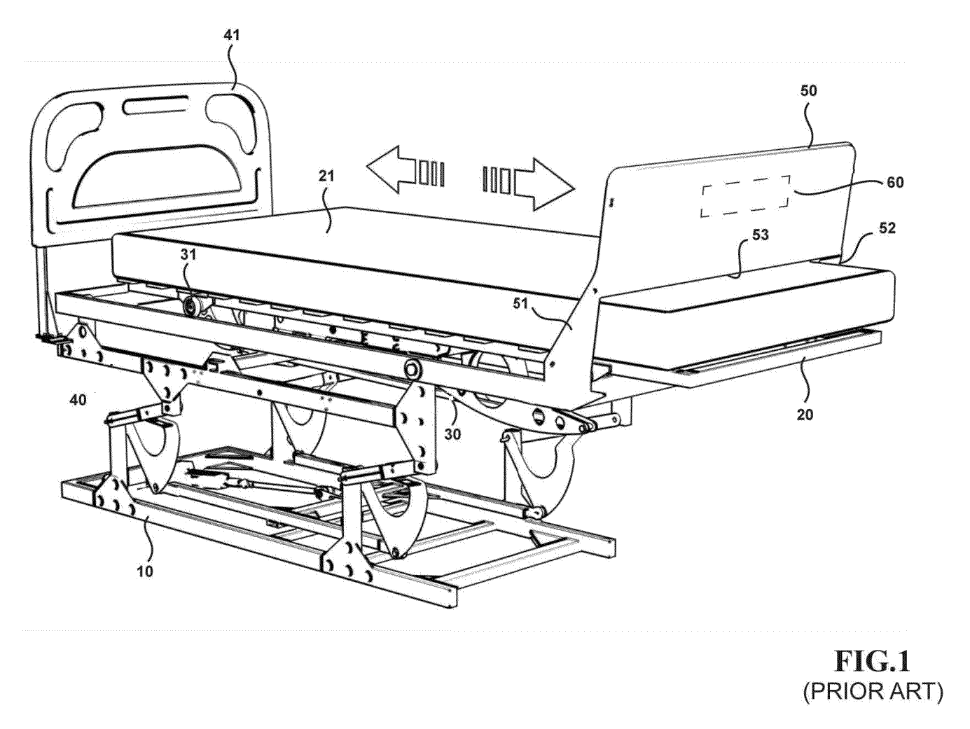

### The Known Multi-Position Supporting Apparatus of FIG. 1

As indicated earlier, the invention can be used in many different types of multi-position supporting apparatus, but for purposes of example, it is described below with respect to the multi-position supporting apparatus illustrated in our co-pending patent applications Ser. Nos. 11/715,410 and 12/542,913. FIG. 1 more particularly illustrates the apparatus of the former application.

The apparatus illustrated in FIG. 1 includes a base, generally designated 10, for supporting the apparatus on a horizontal surface; a body support, generally designated 20, carried by the base for normally supporting the user in a horizontal position; a tilting mechanism, generally designated 30, coupled to and between the base and the body support to enable tilting the body support to a horizontal position, an inclined position, or a vertical position with respect to the base; and a lifting mechanism, generally designated 40, for moving the tilting mechanism 30, and the body support 20 thereon, to any vertical position with respect to the base 10.

In the illustrated embodiment, the head end of lifting mechanism 40 has a headboard 41 fixed thereto, and the foot end of the tilting mechanism 30 has a feet support 50 affixed thereto by a pair of arms 51, 52 straddling the body support 20. The pair of arms define an opening 53 in which the body support is received.

Body support 20 includes a mattress 21 for receiving the user/occupant. The tilting mechanism 30 includes roller bearings 31 engageable with the under surface of body support 20 to enable the tilting mechanism 30, together with the feet support 50, to be shifted longitudinally with respect to the body support 20 and a user thereon.

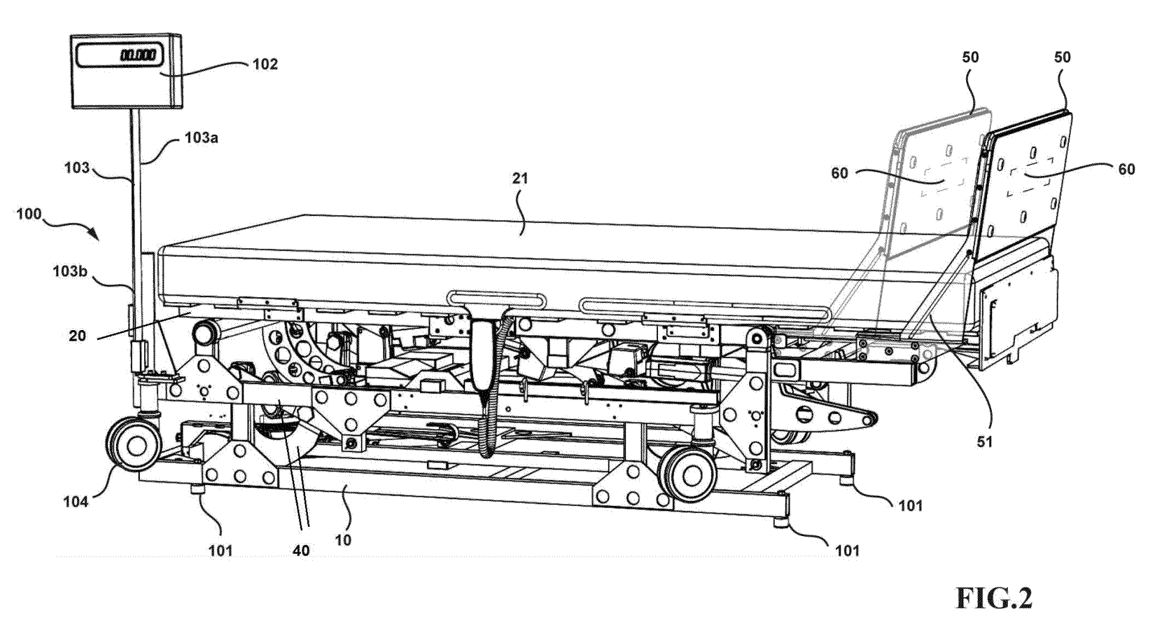

As described more particularly in the above-cited co-pending patent application Ser. No. 11/715,410 (FIG. 2-5), the feet support 50 may be shifted longitudinally with respect to the body support 20. The body support 20, and the mattress 21, with a user thereon, may also be lifted by lifting mechanism 40 to any vertical position, and may be tilted by tilting mechanism 30 to a reclining position for comfort or for any particular treatment. In addition, the body support 20 and its mattress 21 may also be tilted to a vertical position to facilitate the exit of the user from the supporting structure. Feet support 50 may thus be used to engage the under surface of the user's feet, and thereby support the user's weight, when the user, occupying mattress 21, is moved to a downwardly-inclined or vertical position, e.g. when exiting the apparatus.

As further described in the above-cited application Ser. No. 11/715,410, feet support 50 carries a pressure sensor, shown schematically by block 60 in FIG. 1, which senses the pressure applied by the user against the feet support. The output of sensor 60 may be used to start or stop the tilting mechanism when a predetermined pressure is sensed, and/or for actuating an audible or visible alarm to indicate that an excessive pressure is being applied to the user's feet.

Further details of the construction and operation of the supporting apparatus illustrated in FIG. 1 are available from the above-cited co-pending patent application Ser. No. 12/542,913. For example, separate motor drives are provided for the tilting mechanism 30, the lifting mechanism 40, and the feet support 50. In addition, the body support 20 could be constructed of a plurality of pivotal sections, enabling it to support the user, not only in a horizontal position, inclined position or vertical position, but also in a sitting position.

### The Embodiment of the Invention Illustrated in FIGS. 2-6

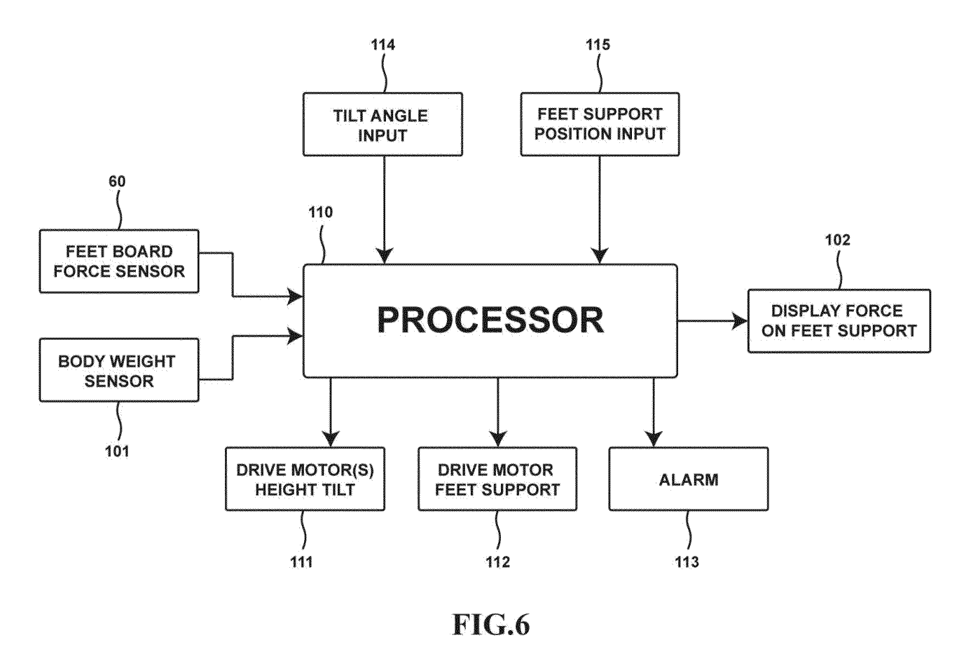

FIGS. 2-5 illustrate a supporting apparatus of a structure available from the above-cited co-pending patent application Ser. No. 11/715,410, modified to incorporate the invention according to one embodiment thereof; and FIG. 6 is a block diagram schematically illustrating the main components in the embodiment of the invention of FIGS. 2-5.

To facilitate understanding, the various elements of the supporting structure in FIGS. 2-5 corresponding to those of FIG. 1 are identified by the same reference numerals as in FIG. 1; and the new elements are identified by reference numerals beginning with 100.

Thus, as shown particularly in FIG. 2, the illustrated supporting apparatus is indicated generally by the reference numeral 100, and the base 10 is of conventional rectangular configuration. The illustrated apparatus includes four sensors 101 on the four corners of the base 10, for sensing the weight of the supporting apparatus, including the user occupying the mattress 21. Since the weight of the apparatus without the user is previously known, or can be separately measured, sensors 101 can be used for measuring merely the weight of the user occupying the mattress 21.

The supporting structure illustrated in FIG. 2 further includes a display unit 102 for displaying various data, as will be described more particularly below with respect to FIG. 6. Display unit 102 is shown as in the form of a separate unit. In the illustrated embodiments, it includes a vertical post 103, constituted of two telescoping sections 103a, 103b, attached to the lifting mechanism 40 to overlie the headboard 41 (FIG. 1).

The lifting mechanism 40 further carries a plurality of wheels or rollers 104 to enable the lifting mechanism 40 to be lowered below the base 10 and to engage the horizontal supporting surface, such as to permit the complete supporting apparatus to be wheeled from one location to another.

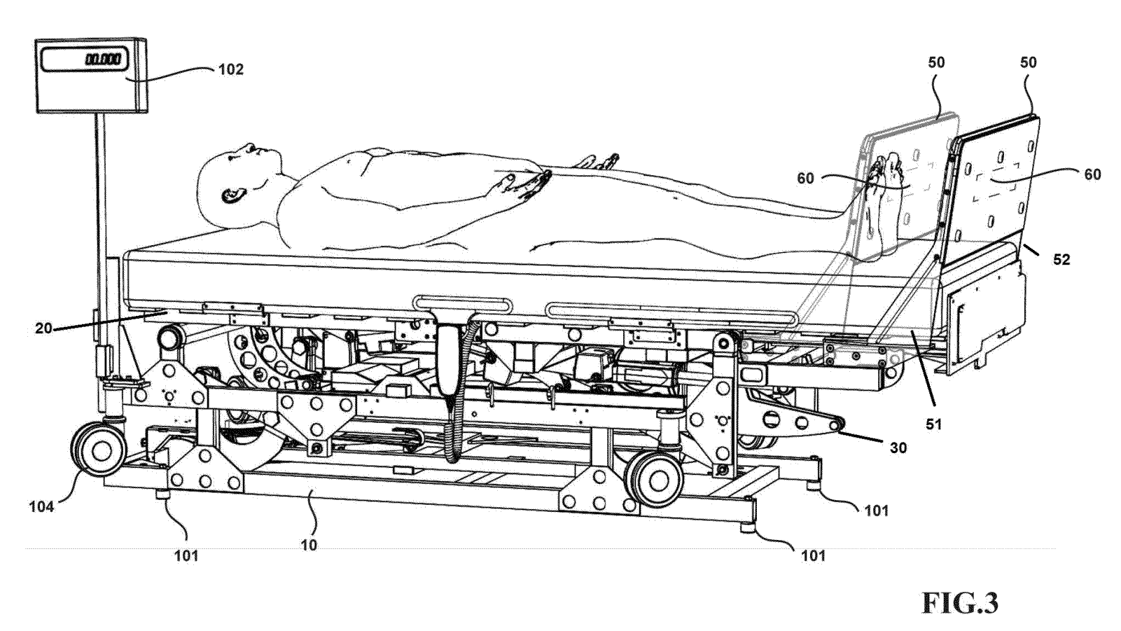

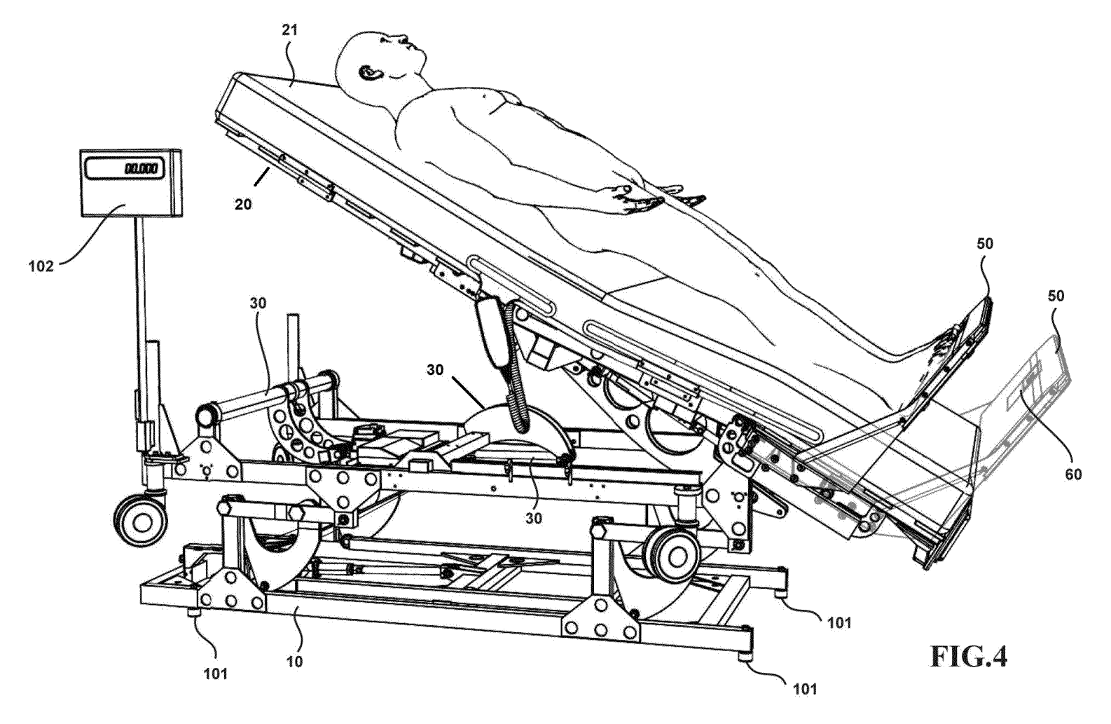

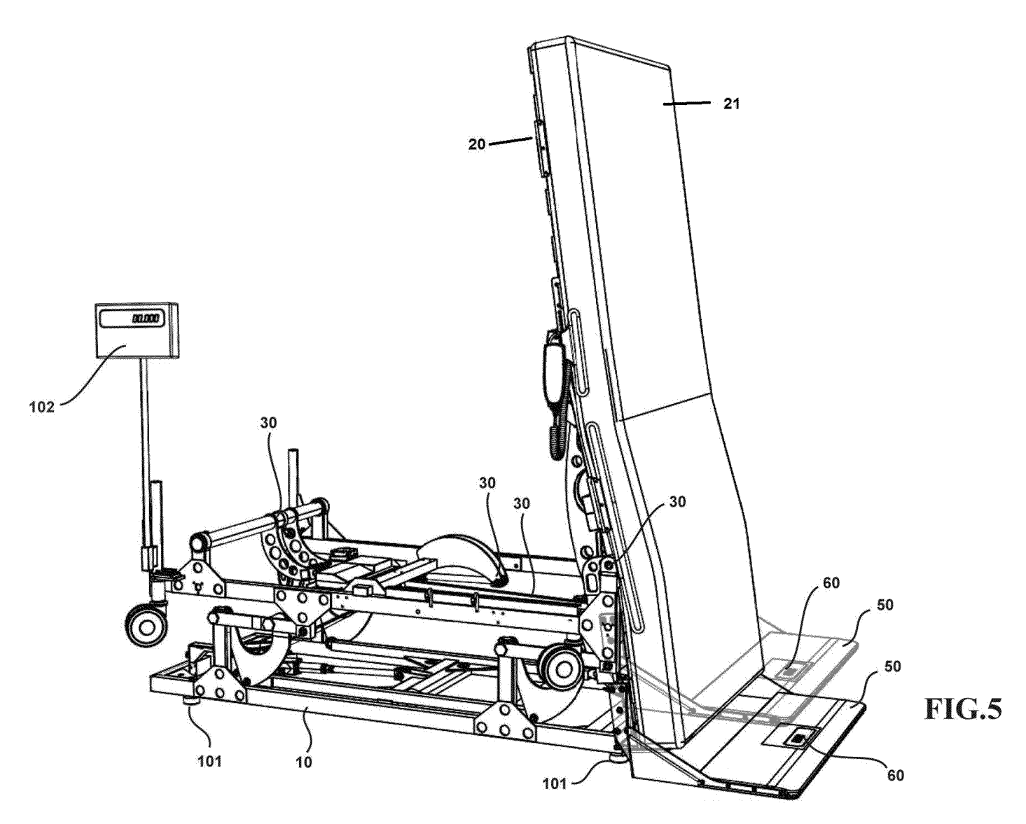

FIGS. 3 and 4 illustrate the user occupying the mattress 21 on the body support 20, in the horizontal and inclined positions, respectively. FIG. 5 illustrates the substantially vertical position of the supporting apparatus to facilitate the exit or entry of the user with respect to the supporting apparatus.

The block diagram of FIG. 6 illustrates the feet-support sensor 60, for sensing the force applied by the user's feet against the feet support 50, and also the weight sensors 101 for sensing the weight of the user occupying the bed. The outputs from these sensors are fed as inputs to a processor 110 which processes this information to produce various outputs, including weight, pressure applied by the user against the support 50, the ratio of the above two outputs, and/or the tilt angle of the body support 20. Each output may be selected for display by a manual selector (not shown).

A particularly important output is the force applied by the user's feet against the feet support 50 in any inclined position or in the vertical position of the user. Knowing this force may be important to the health or comfort of the user in any particular inclined position, and may also indicate an excessive force that may be dangerous to the user. This force, outputted by the feet sensor 60 on the feet support 50, may also be used to control the drive motor or motors, shown schematically at 111 in FIG. 6, of the tilting mechanism 30 and/or lifting mechanism 40, e.g. to start or terminate a tilting operation when a predetermine force has been sensed. The force outputted by the feet sensor 60 may also be used to control the longitudinal movement of the feet support 50 so as to engage the user's feet and to apply a predetermined force against it before the tilt drive motor is operated.

The force outputted by the feet sensor 60 may also be used to control an alarm, schematically shown at 113, which may audibly and/or visually alert an attendant that an excessive force is being applied to the user's feet in any particular inclined position of the user and, thereby, to prevent excessive discomfort or possible injury to the user.

As shown in FIG. 6, all the foregoing outputs are produced by processor 110 in response to the inputs from the feet sensor 60 and the weight sensors 101.

As further schematically shown in FIG. 6, the supporting structure may have an input device, such as a keyboard, enabling a user, or attendant, to input a particular desired tilt angle, as schematically indicated by box 114 in FIG. 6, or to input a particular feet-support position, as indicated by box 115 in FIG. 6.

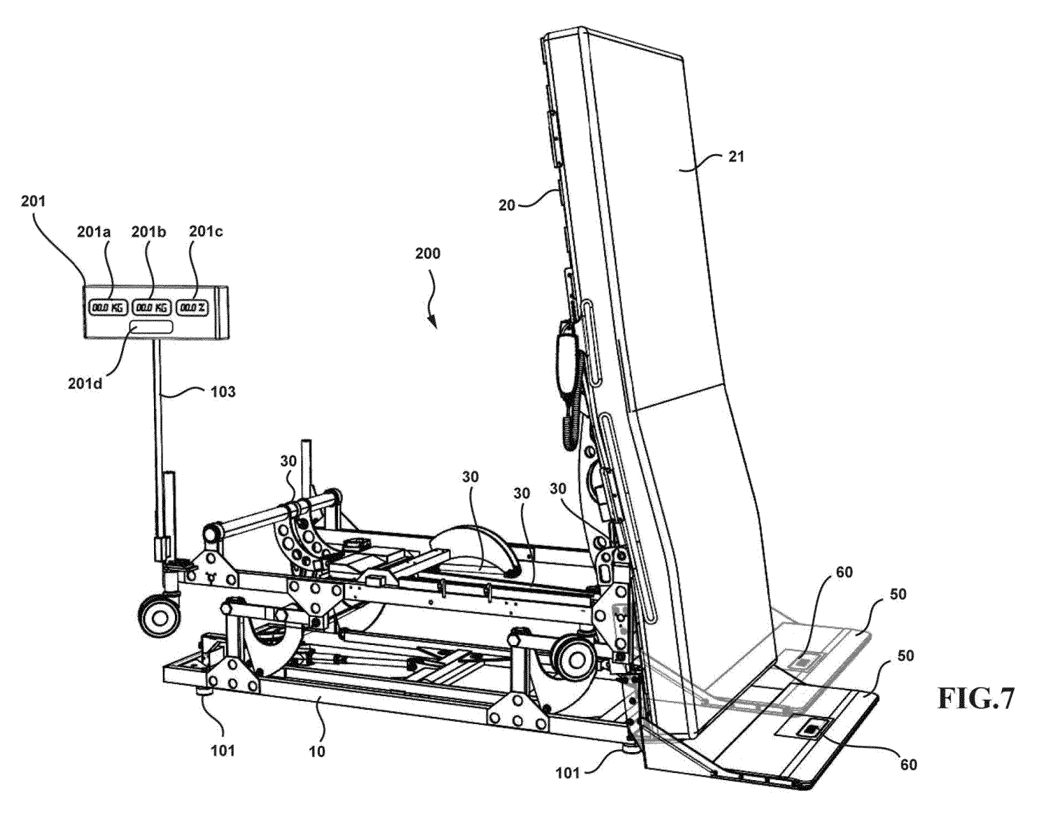

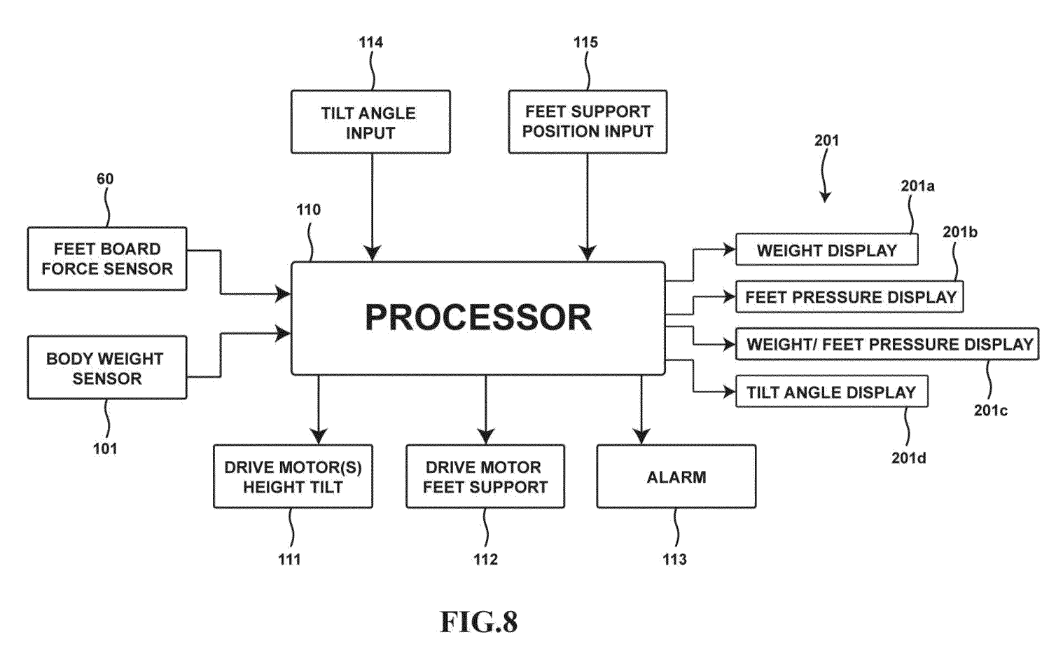

### The Embodiments of FIGS. 7-8

FIG. 7 illustrates another embodiment of the invention wherein the supporting apparatus produces a number of other outputs particularly useful for displaying to the user or to an attendant rendering treatment of the user; and FIG. 8 is a block diagram schematically illustrating the various components of the supporting apparatus of FIG. 7.

Thus, as illustrated in FIGS. 7 and 8, the supporting apparatus, therein generally designated 200 in FIG. 7, includes a display 201 which separately displays a number of outputs, including a first output 201a corresponding to the weight of the user, a second output 201b corresponding to the pressure applied by the user's feet on the feet support 50, a third output 201c corresponding to the ratio of the first and second outputs, and a fourth output 201d corresponding to the angle of tilt of the body support 20 with respect to the base 10. In all other respects, the structure and operation of the embodiment illustrated in FIGS. 7 and 8 are substantially the same as described above with respect to the embodiment of FIGS. 2-6.

While the invention has been described with respect to the supporting apparatus of patent application Ser. No. 11/715,410, wherein the foot-support 50 is driven longitudinally of the body support 20, and the user thereon, it will be appreciated that the invention can also be implemented in the supporting structure described in the above-cited co- pending patent application Ser. No. 12/542,913, wherein the body supporting member is moved longitudinally with respect to the feet support.

The invention is suitable for all types of beds capable of being tilted, and for hospital beds in particular, including those capable of moving the user to the Trendelenburg position, wherein the body is laid on the back in a supine position with the feet higher than the head, as well as in a reverse Trendelenburg position, wherein the body is tilted in the opposite direction.

While the invention has been described with respect to several preferred embodiments, it will be appreciated that these are set forth merely for purposes of example, and that many other variations, modifications and applications of the invention may be made.

What is claimed is:

1. Supporting apparatus for supporting a user in one of a plurality of positions and for moving the user from one position to another, comprising:
a base for supporting the apparatus on a horizontal surface;
a body support carried by the base for supporting the user in a horizontal position;
a tilting mechanism coupled to and between said base and said body support to enable tilting the body support to a horizontal position or inclined position with respect to said base;
a feet support engageable with the under surface of the user's feet;
a pressure-sensor carried by said feet-support for sensing the pressure applied by the user to said feet-support and for producing an output corresponding thereto;
a weight sensor for sensing the weight of the user on the body support and for producing an output corresponding thereto;
and a processor for processing the outputs of said pressure-sensor and said weight-sensor for producing an output corresponding thereto.

2. The supporting apparatus according to claim 1, wherein said base is of rectangular configuration, and said weight sensor comprises a pressure sensor at each of the four corners of the base.

3. The supporting apparatus according to claim 1, wherein said apparatus further comprises a display for displaying an output of the processor.

4. The supporting apparatus according to claim 3, wherein said display is carried by a separate stand-alone unit.

5. The supporting apparatus according to claim 1, wherein said supporting apparatus further comprises a motor drive for driving said tilting mechanism, and wherein said motor drive is controlled by an output of said processor.

6. The supporting apparatus according to claim 5, wherein said motor drive is controlled by an output of said processor to start or stop a tilting operation when a predetermined pressure is applied to the feet-support pressure-sensor.

7. The supporting apparatus according to claim 5, wherein the supporting apparatus further comprises an alarm which is actuated when the pressure sensor on said feet-support senses an excessive pressure.

8. The supporting apparatus according to claim 5, wherein the supporting apparatus further comprises another motor drive for driving said feet-support longitudinally with respect to said body support, and where said another motor drive is also controlled by an output of said processor.

9. The supporting apparatus according to claim 1, wherein said processor produces:
a first output corresponding to the weight of the user;
a second output corresponding to the pressure applied by the user's feet on the feet-support, and
a third output corresponding to the ratio of said first and second outputs.

10. The supporting apparatus according to claim 9, wherein said apparatus further comprises a display for displaying each of said outputs.

11. The supporting apparatus according to claim 9, wherein said supporting apparatus further comprises a motor drive for driving said tilting mechanism, and said motor drive is controlled by either said second or third output from the processor.

12. The supporting apparatus according to claim 11, wherein the supporting apparatus further comprises another motor drive for driving said feet-support longitudinally with respect to said body-support, and wherein said another motor drive is controlled by either said second or third output from the processor.

13. The supporting apparatus according to claim 9, wherein said processor produces a fourth output corresponding to the angle of tilt of the body support with respect to said base.

14. The supporting apparatus according to claim 13, wherein the supporting apparatus further comprises a display for displaying all of said outputs from the processor.

15. The supporting apparatus according to claim 13, wherein said supporting apparatus further comprises an alarm which is actuated by at least one of said outputs.
